(19) United States
(12) Patent Application Publication
(10) Pub. No.: US 2015/0226382 A1
(43) Pub. Date: Aug. 13, 2015

(54) ELECTROLUMINESCENT DEVICE AND APPARATUS APPLYING THE SAME

(71) Applicant: Unistars Corporation, Hsinchu County (TW)

(72) Inventors: Wen-Cheng CHIEN, Hsinchu City (TW); Shang-Yi WU, Hsinchu City (TW); Tien-Hao HUANG, Taoyuan County (TW); Hsin-Hsien HSIEH, Taoyuan County (TW)

(73) Assignee: Unistars Corporation, Hsinchu County (TW)

(21) Appl. No.: 14/177,229

(22) Filed: Feb. 11, 2014

(51) Int. Cl. F21K 99/00; F21V 29/15; F21V 19/04

(52) U.S. Cl. CPC F21K 9/1355; F21V 19/042; F21V 29/15; F21Y 2111/008

(57) ABSTRACT

An electroluminescence device comprises a sandwich structure and a first luminous unit. The sandwich structure comprises a first metal layer, an insulation layer, and a second metal layer stacked in sequence along a stacking direction. The first luminous unit is disposed on a sidewall of the sandwich structure parallel to the stacking direction, wherein the first luminous unit comprises a first electrode and a second electrode connected to the first metal layer and the second metal layer by a solder ball respectively.

### FIELD OF THE INVENTION

The present invention relates to a lighting device and an apparatus applying the same, and more particularly to an electroluminescence device and an apparatus applying the same.

### BACKGROUND OF THE INVENTION

An electroluminescence device, such as a light emitting diode (LED) device, is an electroluminescence semiconductor device benefit by short response time, low temperature, high vibration resistance, low power consumption, low thermal radiation and long life time, and thus is separately applied by consumer electronic products.

FIG. 1 is a three dimensional view illustrating a portion of a LED lighting device 100 in accordance with the prior art. The LED lighting device 100 comprises a plurality of LED units 101 disposed on a single planar substrate 102. Since these LED units 101 are disposed on one side of the single planar substrate 102, such as a printed circuit board (PCB), thus the light emitting direction and beam angles of the LED units 101 are fixed. As a result, it is unlikely to provide lights having a broader beam angular range, for example, a beam angle approximated to 360 degrees, achieved by the LED lighting device 100.

In order to provide lighting devices having a broader beam angular range, another LED lighting device is thus provided. FIG. 2 is a three dimensional view illustrating a portion of an another LED lighting device 200 in accordance with the prior art. The LED lighting device 200 comprises a plurality of LED units 201 disposed on a multiple-plane substrate 202 (or multi-planar substrate). For example, the multiple-plane substrate 202 may be a polygonal columnar structure composed of several planar PCBs, and the LED units 201 are fixed on outer surfaces of the polygonal columnar structure of the multiple-plane substrate 202, and are electrically connected with each other by wires (not shown) established or configured in the columnar shell structure, whereby lights having various emitting directions and beam angles may be provided.

However, since the number of sidewalls of the columnar structure is limited, thus lights emitted from the LED units 201 that are fixed on these sidewalls of the multiple-plane substrate 202 may have limited emitting directions and beam angles. In other words, to provide lights having a beam angle approximated to 360 degrees is still not achieved. In addition, because the plurality of LED units 201 are respectively fixed on one of the PCBs used to constitute the columnar structure, when one or more of the LED units 201 are broken-down or defective, it is necessary to disassemble the columnar structure of the multiple-plane substrate 202 for repairing or changing the damaged or defective LED units 201. Thus the process for repairing or changing the damaged or defective LED units 201 could be rather time consuming and inconvenient. At the worst, disassembling of the columnar structure of the multiple-plane substrate 202 may cause damages of the LED lighting device 200.

Therefore, there is a need of providing an electroluminescence device and an apparatus applying the same to obviate the drawbacks and problems encountered from the prior art.

### SUMMARY OF THE INVENTION

According to one aspect of the present invention, an electroluminescence device is provided, wherein the electroluminescence device comprises a sandwich structure and a first luminous unit. The sandwich structure comprises a first metal layer, an insulation layer, and a second metal layer stacked in sequence along a stacking direction. The first luminous unit is disposed on a first sidewall of the sandwich structure parallel to the stacking direction, wherein the first luminous unit comprises a first electrode and a second electrode connected to the first metal layer and the second metal layer by a solder ball respectively.

In one embodiment of the present invention, the insulation layer is a flexible material layer made of material selected from a group consisting of epoxy, silicon (Si), polyimide and arbitrary combinations thereof. In one embodiment of the present invention, the first metal layer and the second metal layer comprise aluminum (Al) or copper (Cu) respectively; other material that can be properly adhered with the solder ball may be also suitable for use to constitute the first metal layer and the second metal layer.

In one embodiment of the present invention, the first luminous unit is an LED chip or an LED module.

In one embodiment of the present invention, the electroluminescence device further comprises a transparent isolation layer covering on the first luminous unit and a portion of the sandwich structure, so as to encapsulate the first luminous unit.

In one embodiment of the present invention, the electroluminescence device further comprises a transparent material filled among the transparent isolation layer, the first luminous unit and the portion of the sandwich structure covered by the transparent isolation layer.

In one embodiment of the present invention, the electroluminescence device further comprises a second luminous unit disposed on the first sidewall or a second sidewall of the sandwich structure parallel to the stacking direction, directly contacting with the first metal layer and the second metal layer, and forming a parallel connection with the first luminous unit.

According to another aspect of the present invention, a lighting apparatus is provided, wherein the lighting apparatus comprises a base and a first electroluminescence device fixed on and electrically connected to the base, wherein the electroluminescence device comprises a sandwich structure and a first luminous unit. The sandwich structure comprises a first metal layer, an insulation layer, and a second metal layer stacked in sequence along a stacking direction. The first luminous unit is disposed on a first sidewall of the sandwich structure parallel to the stacking direction. The first luminous unit comprises a first electrode and a second electrode connected to the first metal layer and the second metal layer by a solder ball respectively.

In one embodiment of the present invention, the insulation layer is a flexible material layer made of material selected from a group consisting of epoxy, Si, polyimide and arbitrary combinations thereof. In one embodiment of the present invention, the first metal layer and the second metal layer comprise Al or Cu respectively.

In one embodiment of the present invention, the first luminous unit is an LED chip or an LED module.

In one embodiment of the present invention, the base comprises a socket allowing the sandwich structure plugged therein.

In one embodiment of the present invention, the socket comprises a third electrode and a fourth electrode used to contact with the first metal layer and the second metal layer respectively.

In one embodiment of the present invention, the first electroluminescence device further comprises a transparent isolation layer covering on the first luminous unit and a portion of the sandwich structure, so as to encapsulate the first luminous unit.

In one embodiment of the present invention, the first electroluminescence device further comprises a transparent material filled among the transparent isolation layer, the first luminous unit and the portion of the sandwich structure covered by the transparent isolation layer.

In one embodiment of the present invention, the lighting apparatus further comprises a transparent shell structure engaged with the base to encapsulate the first electroluminescence device.

In one embodiment of the present invention, the first electroluminescence device further comprises a second luminous unit disposed on the first sidewall or a second sidewall of the sandwich structure parallel to the stacking direction, directly contacting with the first metal layer and the second metal layer, and forming a parallel connection with the first luminous unit.

In one embodiment of the present invention, the lighting apparatus further comprises a second electroluminescence device fixed on and electrically connected to the base, and forming a parallel connection with the first electroluminescence device.

In accordance with aforementioned embodiments, an electroluminescence device and a lighting apparatus applying the same are provided, wherein the electroluminescence device comprises a flexible sandwich structure and at least one luminous unit disposed on the sandwich structure. The sandwich structure at least comprises two metal layers and an insulation layer used to isolate the two metal layers, and the luminous unit is disposed on a sidewall of the sandwich structure that is parallel to a stacking direction along which these two metal layers and the insulation layer are stacked. Since the emitting direction of the luminous unit can be varied by bending the flexible sandwich structure, thus lights with different emitting directions and beam angles can be provided according to the design requirements and specifications of a lighting apparatus applying the electroluminescence device. In addition, when a plurality of the identical luminous units are disposed on different sidewalls of the sandwich structure parallel to the stacking direction, lights having a broader beam angular range, for example a beam angle approximated to 360 degrees, can be provided by the electroluminescence device.

Besides a plurality of the electroluminescence devices may be integrated by a base to form a lighting apparatus. Since theses electroluminescence devices are integrated in a manner of forming a parallel connection, thus when one of the electroluminescence devices is broken-down the operation of the other electroluminescence devices may not be affected, and the broken electroluminescence device can be repaired or changed without disassembling the lighting apparatus, whereby the process for repairing or changing the damaged electroluminescence device can be conducted in a more convenient way, and the repairing cost can be significant reduced.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a three dimensional view illustrating a portion of a LED lighting device in accordance with the prior art;

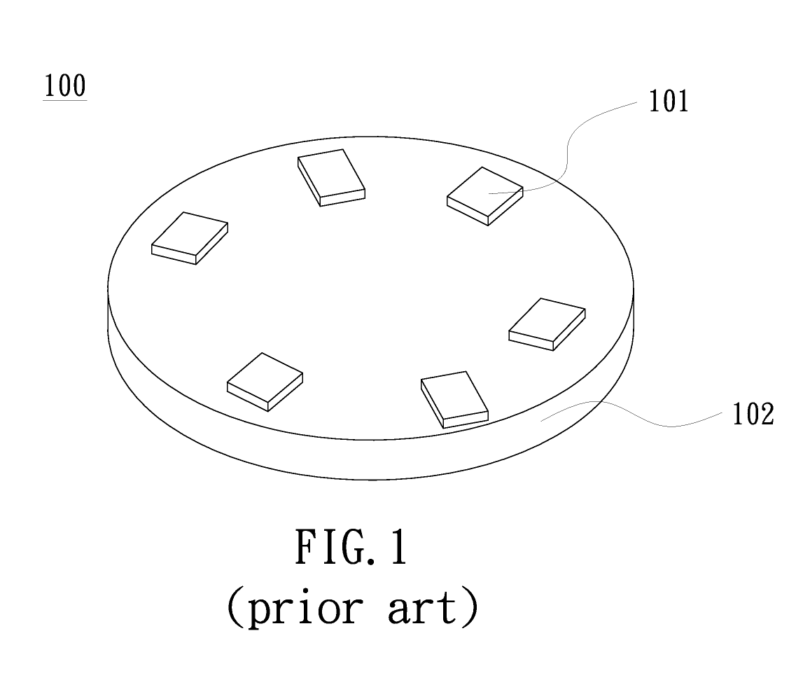

FIG. 2 is a three dimensional view illustrating a portion of another LED lighting device in accordance with the prior art;

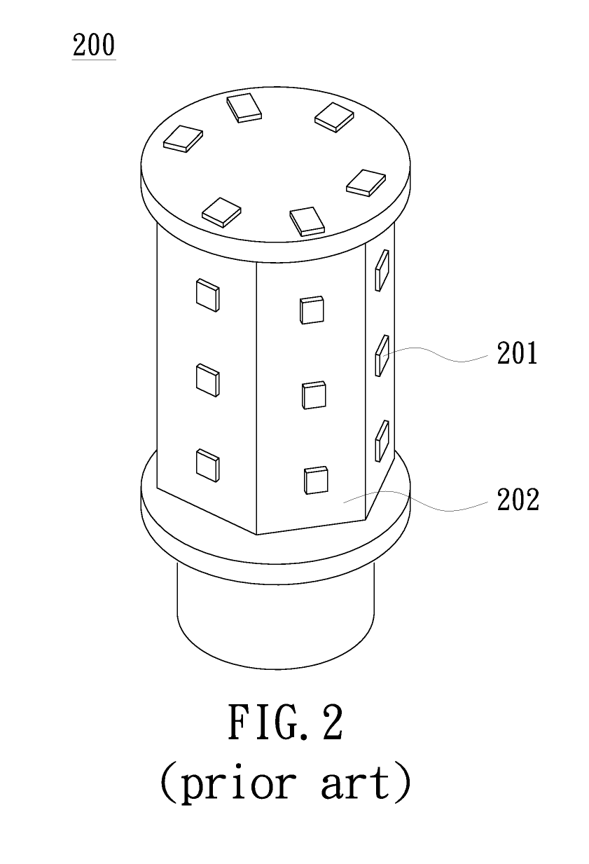

FIG. 3 is a three dimensional view illustrating an electroluminescence device in accordance with one embodiment of the present invention;

FIG. 4 is an exploded diagram illustrating the sandwich structure depicted in FIG. 3;

FIG. 5 is a three dimensional view illustrating an electroluminescence device in accordance with another embodiment of the present invention;

FIG. 6 is a three dimensional view illustrating a lighting apparatus in accordance with one embodiment of the present invention;

FIG. 7 is a three dimensional view illustrating a lighting apparatus in accordance with another embodiment of the present invention; and

FIG. 8 illustrates an operation status of the lighting apparatus depicted in FIG. 7.

### DETAILED DESCRIPTION OF PREFERRED EMBODIMENTS

An electroluminescence device and an apparatus applying the same are provided to provide lights having a broader range of beam angles. The present invention will now be described more specifically with reference to the following embodiments. It is to be noted that the following descriptions of preferred embodiments of this invention are presented herein for purposes of illustration and description only. It is not intended to be limited to the precise form disclosed.

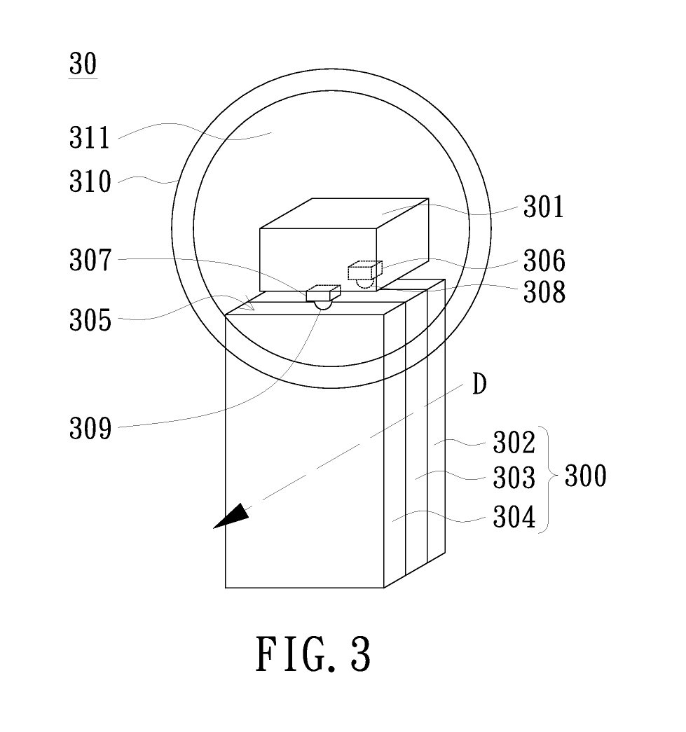

FIG. 3 is a three dimensional view illustrating an electroluminescence device 30 in accordance with one embodiment of the present invention.

The electroluminescence device 30 comprises a sandwich structure 300 and a luminous unit 301, wherein the sandwich structure 300 is a thin film stacked structure comprising a first metal layer 302, an insulation layer 303 and a second metal layer 304 stacked in sequence along a stacking direction D; and the luminous unit 301 is disposed on a sidewall 305 of the sandwich structure 300 parallel to the stacking direction D.

In some embodiments of the present invention, the first metal layer 302 and the second metal layer 304 may be made of material that comprises Al or Cu; other material that can be properly adhered with the solder ball may be also suitable for use to constitute the first metal layer 302 and the second metal layer 304. In the present embodiment, the first metal layer 302 and the second metal layer 304 are made of Cu. However, it is not limited to just copper, in some other embodiments, the first metal layer 302 and the second metal layer 304 are made of different materials. The insulation layer 303 may be a glass substrate, a plastic substrate or a thin film structure made of any suitable insulation material. In the present embodiment, the insulation layer 303 is a flexible material layer made of epoxy, Si, polyimide or the arbitrary combinations thereof.

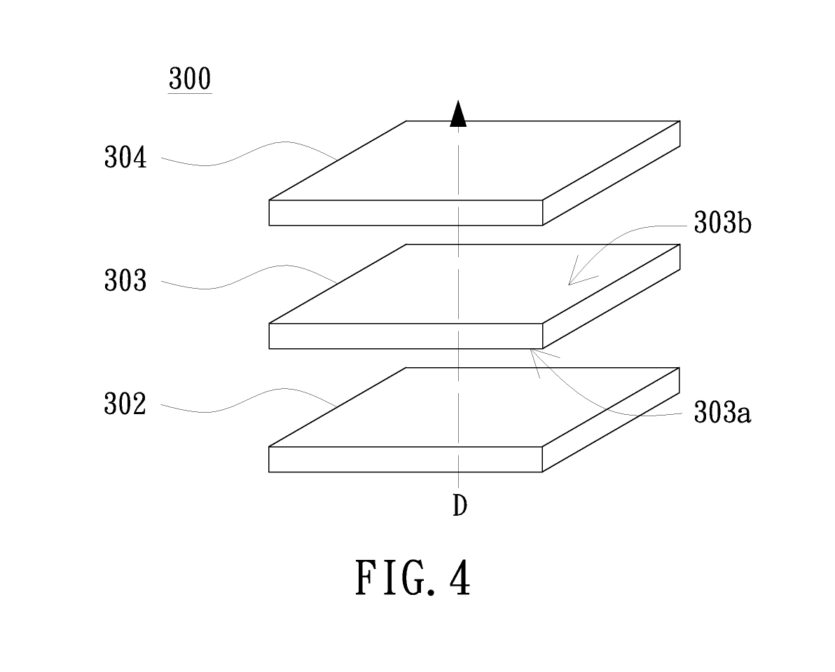

FIG. 4 is an exploded view illustrating the sandwich structure 300 depicted in FIG. 3. In the present embodiment, the first metal layer 302, the insulation layer 303 and the second metal layer 304 are respectively adhered on to two opposite surfaces 303a and 303b of the insulation layer 303 by a bonding process, so as to form the thin film stacked structure of the sandwich structure 300. However, the process for forming the sandwich structure 300 is not limited to above. In some other embodiments of the present invention, the first metal layer 302 and the second metal layer 304 are formed by a metal deposition process being performed on the two opposite surfaces 303a and 303b of the insulation layer 303 respectively, whereby the thin film stacked structure of the sandwich structure 300 is formed along the normal direction (stacking direction D) perpendicular to the two opposite surfaces 303a and 303b of the insulation layer 303.

Refer to FIG. 3 again, the luminous unit 301 comprises a first electrode 306 and a second electrode 307, and the first metal layer 302 and the second metal layer 304 are connected to the first electrode 306 and the second electrode 307 through a plurality of solder balls 308 and 309, respectively, so as to form an electrical connection between the sandwich structure 300 and the luminous unit 301.

In some embodiments of the present invention, the luminous unit 301 may be an unpackaged LED chip, an unpackaged organic LED chip or an unpackaged laser diode chip. In some other embodiments of the present invention, the luminous unit 301 may be a packaged LED module, a packaged organic LED module or a packaged laser diode module. In the present embodiment, the luminous unit 301 is a packaged LED module. In order to protect the unpackaged LED chip, the electroluminescence device 30 further comprises a transparent isolation layer 310, other than the protection layer (not shown) provided by the packaged structure, covering on the luminous unit 301 and a portion of the sandwich structure 300, so as to encapsulate the luminous unit 301. In addition, a transparent material 311 is filled among the transparent isolation layer 310, the luminous unit 301 and the portion of the sandwich structure 300 covered by the transparent isolation layer 310 (see FIG. 3). The transparent material 311 preferably is epoxy resin or polyimide.

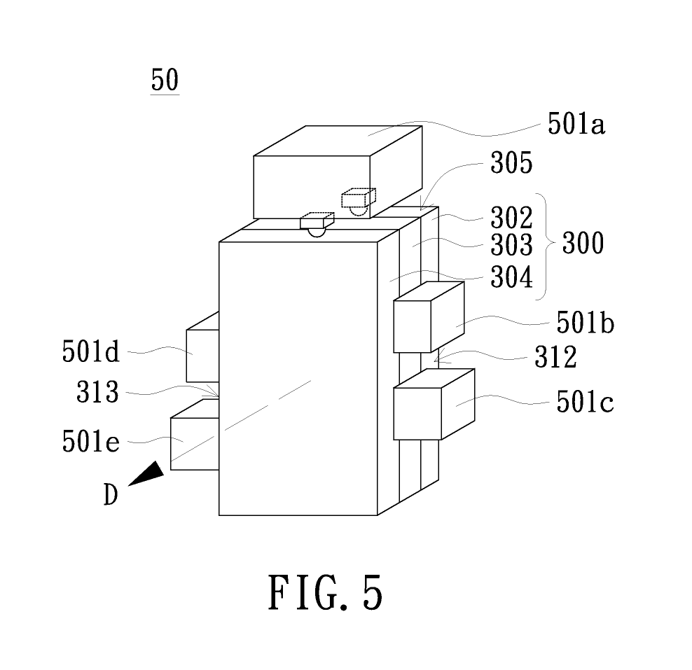

FIG. 5 is a three dimensional view illustrating an electroluminescence device 50 in accordance with one embodiment of the present invention, wherein the structure of the electroluminescence device 50 is similar to that of the electroluminescence device 30 depicted in FIG. 3, except that the electroluminescence device 50 comprises a plurality of luminous units, such as a plurality of second luminous units 501a, 501b, 501c, 501d and 501e, each of which is identical with the luminous unit 301, and is connected with each other to form a parallel connection. In the present embodiment, elements similar to that depicted in FIG. 3 are illustrated by similar reference numbers and will not be redundantly described therein.

In the present embodiment, the luminous unit 501a is disposed on the sidewall 305 of the sandwich structure 300; the luminous units 501b and 501c are disposed on the sidewall 312 of the sandwich structure 300, and the sidewall 312 is connected to the sidewall 305; and the luminous units 501d and 501e are disposed on the sidewall 313 of the sandwich structure 300, and the sidewall 313 is connected to the sidewall 305 and opposite to the sidewall 312 of the sandwich structure 300. The sidewalls 305, 312 and 313 are parallel to the stacking direction D along which the first metal layer 302, the insulation layer 303 and the second metal layer 304 are stacked in sequence.

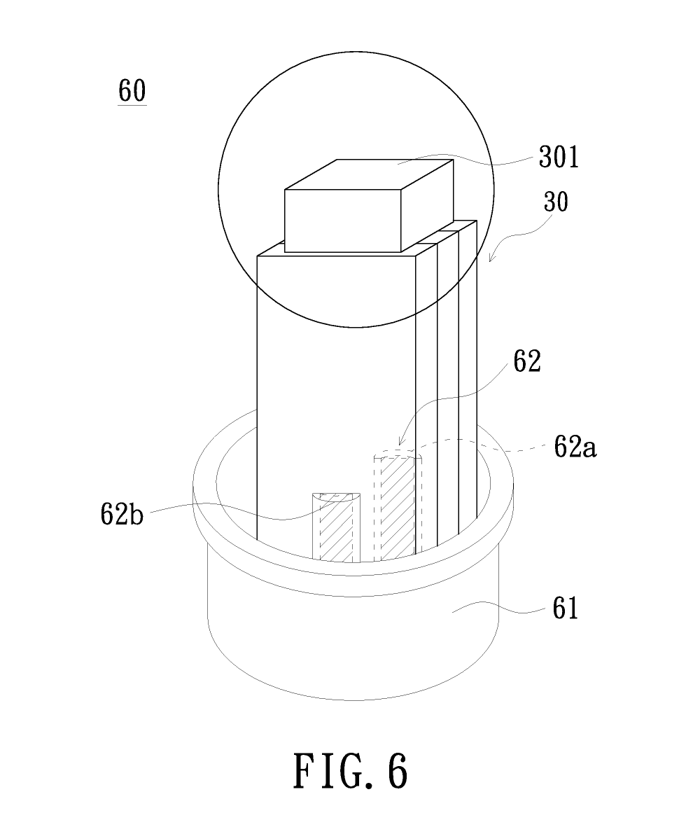

FIG. 6 is a three dimensional view illustrating a lighting apparatus 60 in accordance with one embodiment of the present invention, wherein the lighting apparatus 60 comprises an electroluminescence device identical with the electroluminescence device 30 depicted in FIG. 3 (thereinafter referred to as the electroluminescence device 30) and a base 61 used to engaged with the electroluminescence device 30. The base 61 comprises a socket 62 composed by two clamp electrodes 62a and 62b and allowing the sandwich structure 300 to be plugged therein. In practice, when the electroluminescence device 30 is engaged with the base 61, the two clamp electrodes 62a and 62b are in contact with the first metal layer 302 and the second metal layer 304 of the sandwich structure 300 respectively. Thus, a power supply can be electrically connected to the luminous unit 301 through the base 61.

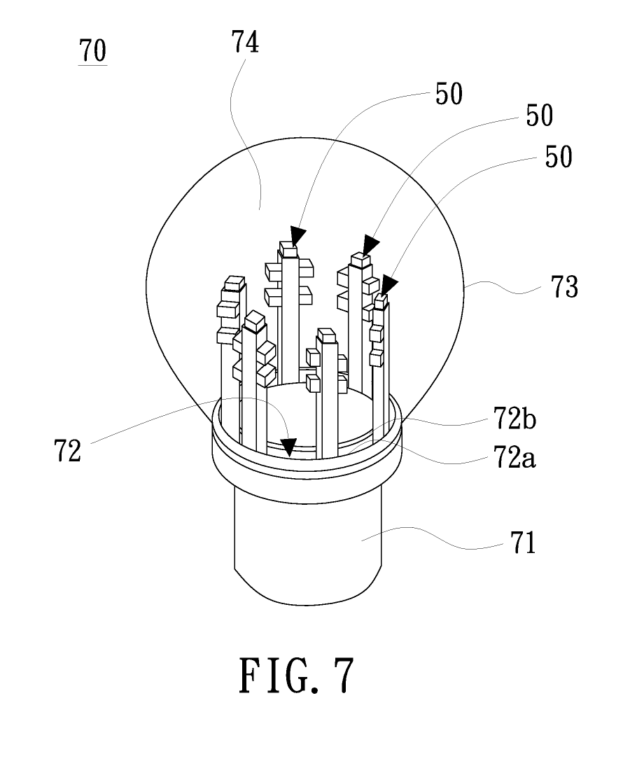

FIG. 7 is a three dimensional view illustrating a lighting apparatus 70 in accordance with another embodiment of the present invention, wherein the lighting apparatus 70 comprises a plurality of electroluminescence devices each of which is identical with the electroluminescence device 50 depicted in FIG. 5 (thereinafter referred to as the electroluminescence devices 50) and a base 71 used to engaged with the electroluminescence devices 50. In the present embodiment, the base 71 comprises a socket 72 composed by two ring-shaped electrodes 72a and 72b and allowing a plurality of sandwich structures 300 of the electroluminescence devices 50 to be plugged therein. In practice, when the electroluminescence devices 50 are engaged with the base 71, the sandwich structure 300 of each electroluminescence device 50 is plugged in the socket 72 defined by the two ring-shaped electrodes 72a and 72b, and the first metal layer 302 and the second metal layer 304 of the corresponding sandwich structure 300 are directly in contact with the two ring-shaped electrodes 72a and 72b, respectively. Thus, a power supply can be electrically connected to the luminous units 501a, 501b, 501c, 501d and 501e of each electroluminescence device 50 through the base 71 to form a parallel connection.

In addition, for purposes of protecting the electroluminescence devices 50, operation convenience and safety, the lighting apparatus 70 further comprises a transparent shell structure 73, which is made of glass or plastic material, to be engaged with the base 71 to encapsulate the electroluminescence devices 50. In some embodiments of the present invention, the lighting apparatus 70 further comprises a transparent material 74, such as oils, polymers or plastics either in solid or liquid form, to be filled among the base 71, the electroluminescence devices 50 and the transparent shell structure 73, wherein the refraction index of the transparent material 74 may be varied according to the design requirements and specifications of a lighting apparatus 70 in order to provide different luminous performance.

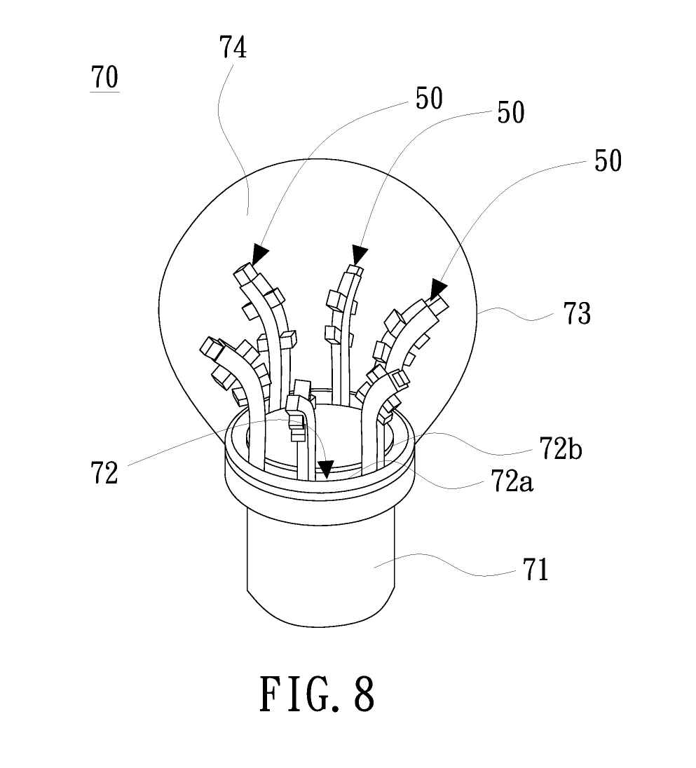

In order to increase the irradiation range of the lighting apparatus 70, the flexible sandwich structures 300 of the electroluminescence devices 50 can be bent outwards to form a plurality of arcs radially arranged (as shown in FIG. 8). In practice, the bending angles of each sandwich structures 300 can be determined and then adjusted according to the number of the electroluminescence devices 50 and the design requirements of the lighting apparatus 70.

In accordance with aforementioned embodiments, an electroluminescence device and a lighting apparatus applying the same are provided, wherein the electroluminescence device comprises a flexible sandwich structure and at least one luminous unit disposed on the sandwich structure. The sandwich structure at least comprises two metal layers and an insulation layer used to isolate the two metal layers, and the luminous unit is disposed on a sidewall of the sandwich structure that is parallel to a stacking direction along which these two metal layers and the insulation layer are stacked. Since the emitting direction of the luminous unit can be varied by bending the flexible sandwich structure, thus lights with different emitting directions and beam angles can be provided according to the design requirements and specifications of a lighting apparatus applying the electroluminescence device. In addition, when a plurality of the identical luminous units are disposed on different sidewalls of the sandwich structure parallel to the stacking direction, lights having a broader beam angular range can be provided by the electroluminescence device.

Besides a plurality of the electroluminescence devices may be integrated by a base to form a lighting apparatus. Since theses electroluminescence devices are integrated in a manner of forming a parallel connection, thus when one of the electroluminescence devices is damaged, the operation of the other electroluminescence devices may not be affected, and the broken electroluminescence device can be repaired or changed without disassembling the lighting apparatus, whereby the process for repairing or changing the broken electroluminescence device can be conducted in a more convenient way, and the repairing cost can be significantly reduced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An electroluminescence device, comprising:
a sandwich structure; comprising a first metal layer, an insulation layer and a second metal layer stacked in sequence along a stacking direction; and
a first luminous unit disposed on a first sidewall of the sandwich structure parallel to the stacking direction;
wherein the first luminous unit comprises a first electrode and a second electrode connected to the first metal layer and the second metal layer by a solder ball respectively.

2. The electroluminescence device according to claim 1, wherein the insulation layer is a flexible material layer made of a material selected from a group consisting of epoxy, silicon (Si), polyimide and arbitrary combinations thereof.

3. The electroluminescence device according to claim 1, wherein the first metal layer and the second metal layer comprise aluminum (Al) or copper (Cu) respectively.

4. The electroluminescence device according to claim 1, wherein the first luminous unit is a light emitting diode (LED) chip or an LED module.

5. The electroluminescence device according to claim 1, further comprising a transparent isolation layer covering on the first luminous unit and a portion of the sandwich structure, so as to encapsulate the first luminous unit.

6. The electroluminescence device according to claim 5, further comprising a transparent material filled among the transparent isolation layer, the first luminous unit and the portion of the sandwich structure covered by the transparent isolation layer.

7. The electroluminescence device according to claim 1, further comprising a second luminous unit disposed on the first sidewall or a second sidewall of the sandwich structure parallel to the stacking direction, directly contacting with the first metal layer and the second metal layer, and forming a parallel connection with the first luminous unit.

8. A lighting apparatus, comprising:
a first electroluminescence device, comprising:
a sandwich structure; comprising a first metal layer, an insulation layer and a second metal layer stacked in sequence along a stacking direction; and
a first luminous unit disposed on a first sidewall of the sandwich structure parallel to the stacking direction;
wherein the first luminous unit comprises a first electrode and a second electrode connected to the first metal layer and the second metal layer by a solder ball respectively; and
a base, fixing and electrically connecting to the first electroluminescence device.

9. The lighting apparatus according to claim 8, wherein the insulation layer is a flexible material layer made of material selected from a group consisting of epoxy, Si, polyimide and arbitrary combinations thereof.

10. The lighting apparatus according to claim 8, wherein the first metal layer and the second metal layer comprise Al or copper Cu respectively.

11. The lighting apparatus according to claim 8, wherein the first luminous unit is an LED chip or an LED module.

12. The lighting apparatus according to claim 8, wherein the base comprises a socket allowing the sandwich structure to be plugged therein.

13. The lighting apparatus according to claim 12, wherein the socket comprises a third electrode and a fourth electrode, and the third electrode and the fourth electrode are contacting with the first metal layer and the second metal layer, respectively.

14. The lighting apparatus according to claim 8, wherein the first electroluminescence device further comprises a transparent isolation layer covering on the first luminous unit and a portion of the sandwich structure, so as to encapsulate the first luminous unit.

15. The lighting apparatus according to claim 14, wherein the first electroluminescence device further comprises a transparent material filled among the transparent isolation layer, the first luminous unit and the portion of the sandwich structure covered by the transparent isolation layer.

16. The lighting apparatus according to claim 8, further comprising a transparent shell structure engaged with the base to encapsulate the first electroluminescence device.

17. The lighting apparatus according to claim 8, wherein the first electroluminescence device further comprises a second luminous unit disposed on the first sidewall or a second sidewall of the sandwich structure parallel to the stacking direction, directly contacting with the first metal layer and the second metal layer, and forming a parallel connection with the first luminous unit.

18. The lighting apparatus according to claim 8, further comprising a second electroluminescence device fixed on and electrically connected to the base, and forming a parallel connection with the first electroluminescence device.
